(19) United States
(12) Patent Application Publication
(10) Pub. No.: US 2005/0276190 A1
(43) Pub. Date: Dec. 15, 2005

(54) Control circuit for optical disk apparatus and method of controlling record/playback of optical disk

(76) Inventors: Tomonori Kamiya, Aichi (JP); Takeshi Kura, Gifu (JP); Yukihiko Shigeoka, Gifu (JP); Naohiro Nishiwaki, Gifu (JP)

Correspondence Address: FISH & RICHARDSON P.C., P.O. BOX 1022, MINNEAPOLIS, MN, 55440-1022, US

(21) Appl. No.: 11/148,436

(22) Filed: Jun. 9, 2005

(30) Foreign Application Priority Data
Jun. 10, 2004 (JP) 2004-173185

(51) Int. Cl. G11B 5/09; G11B 7/24

(52) U.S. Cl. 369/53.2; 369/47.1; 369/59.1

(57) ABSTRACT

A control circuit provided in an optical disk apparatus which apparatus has a motor to move an optical pickup unit for performing record/playback control of an optical disk in a radial direction of the optical disk, sets a plurality of concentric annular zones on the optical disk, and performs record/playback control, for each zone, of the optical disk. The control circuit comprises a pulse period detector for detecting pulse periods of a periodic pulse control signal which drives the motor; and a zone determination section that determines the zone which the optical pickup unit is facing on the basis of the number of pulse period detection times detected by the pulse period detector.

### CROSS-REFERENCE TO RELATED APPLICATIONS

The present application claims priority from Japanese Patent Application No. 2004-173185 filed on Jun. 10, 2004, which is herein incorporated by reference.

### BACKGROUND OF THE INVENTION

1. Field of the Invention

The present invention relates to a control circuit for an optical disk apparatus and a method of controlling record/playback of an optical disk.

2. Description of the Related Art

As illustrated in FIG. 11, it has been proposed for optical disks compliant with CD standards (such as CD-DA, CD-ROM, and CD±R/RW) and DVD standards (such as DVD±R/RW, and DVD-RAM/ROM) that having set a plurality of concentric annular zones on the disk surface, optimum control of the record/playback of the optical disk is performed for each zone.

For example, due to production variation in the manufacture of them, warpage or non-uniformity in thickness of optical disks occurs. Accordingly, for each zone, tilt control is performed so as to make the optical axis of laser light emitted from an optical pickup unit orthogonal to the optical disk.

Furthermore, in order to provide the features of both CLV and CAV methods for rotation drive of optical disks, rotation speed is controlled on a zone basis. For example, a ZCLV method wherein a linear speed is constant in each zone, or a ZCAV method wherein an angular speed is constant in each zone is performed.

In order to perform record/playback for each zone as above, optical disk apparatuses that control the record and/or playback of an optical disk need to determine in which zone the position onto which laser light emitted from an optical pickup unit is irradiating is located in advance before the record/playback of the optical disk.

Accordingly, in conventional optical disk apparatuses, a microcomputer (also called a system controller) controlling the whole of the apparatus determines the zone based on physical addresses on the optical disk read out by the optical pickup unit. See, for example, Japanese Patent Application Laid-Open Publication No. 11-339280. Note that physical addresses on the optical disk are addresses defined in an ATIP format for CD-R/RW media, an LPP format for DVD−R/RW media, an ADIP format for DVD+R/RW media, or a CAPA format for DVD-RAM media.

In recent years, in order to deal with various optical disk media, the microcomputer of optical disk apparatuses is required to perform complex, fast overall control of the record/playback of an optical disk. Meanwhile, the microcomputer performs the zone determination based on physical addresses read out by the optical pickup unit before and also during the record/playback of the optical disk. That is, the problem occurs that due to the process load of the zone determination, the control of record/playback of the optical disk other than the zone determination by the microcomputer is delayed.

Moreover, in a seek operation to seek for a desired position on an optical disk, or the like, the optical pickup unit is usually moved from a current position to a target position, and at this time, it is often the case that positioning the optical pickup unit at the target position is unstable. In this case, the physical address on the optical disk read out by the optical pickup unit may be different from the physical address corresponding to the desired position on the optical disk, and further, in the worst case scenario, physical addresses on the optical disk could not be read out by the optical pickup unit.

As such, cases occur where physical addresses on the optical disk read out by the optical pickup are not appropriate or where physical addresses on the optical disk cannot be read out by the optical pickup unit. As a result, the problem occurs that the zone determination based on physical addresses on the optical disk and thus optimum control of the record/playback cannot be performed for each zone of the optical disk.

### SUMMARY OF THE INVENTION

To solve the above and other problems, according to a one aspect of the present invention there is provided a control circuit provided in an optical disk apparatus which apparatus has a motor to move an optical pickup unit for performing record/playback control of an optical disk in a radial direction of the optical disk, sets a plurality of concentric annular zones on the optical disk, and performs record/playback control, for each zone, of the optical disk, the control circuit comprising a pulse period detector for detecting pulse periods of a periodic pulse control signal which drives the motor; and a zone determination section that determines the zone which the optical pickup unit is facing on the basis of the number of pulse period detection times detected by the pulse period detector.

According to the present invention, there is provided a control circuit for an optical disk apparatus and method of controlling record/playback of an optical disk, which appropriately controls the record/playback for each zone set on the optical disk.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram for explaining the whole configuration of an optical disk apparatus according to an embodiment of the present invention;

FIG. 2 is a diagram for explaining a short jump according to the embodiment of the present invention;

FIG. 3 is a diagram for explaining a long jump according to the embodiment of the present invention;

FIG. 4 is a diagram for explaining A/B phase current setting signals according to the embodiment of the present invention;

FIG. 5 is a diagram for explaining a relationship between pulse periods of the A/B phase current setting signals, the number of rotations of a stepping motor, and the movement amount of an optical pickup unit according to the embodiment of the present invention;

FIG. 6 is a diagram for explaining information stored in a zone control parameter value storage according to the embodiment of the present invention;

FIG. 7 is a diagram for explaining the configuration of a digital signal processing device according to the embodiment of the present invention;

FIG. 8 is a diagram for explaining main signals of a zone determination counter according to the embodiment of the present invention;

FIG. 9 is a diagram for explaining the operation of the zone determination counter according to the embodiment of the present invention;

FIG. 10 is a flow chart for explaining the operation of the digital signal processing device according to the embodiment of the present invention; and

FIG. 11 is a diagram for explaining zones on an optical disk.

### DETAILED DESCRIPTION OF THE INVENTION

At least the following matters will be made clear by the explanation in the present specification and the description of the accompanying drawings.

===Configuration of an Optical Disk Apparatus===

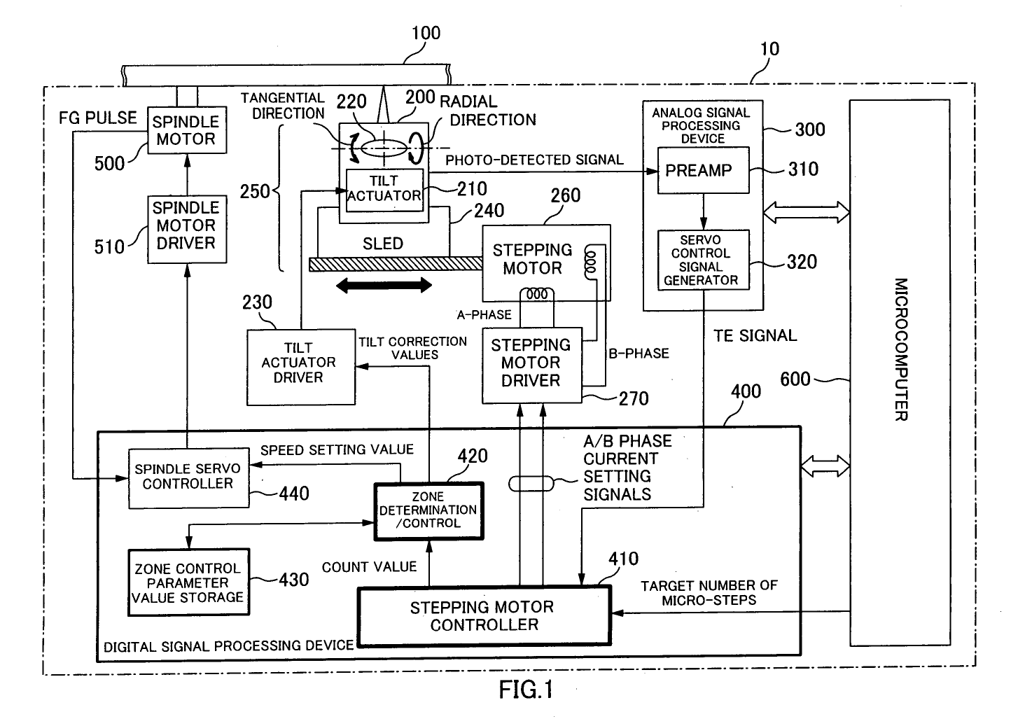

FIG. 1 is a diagram illustrating the whole configuration of an optical disk apparatus 10 according to an embodiment of the present invention. In the present embodiment, an optical disk 100 is a medium compliant with a CD standard (CD-DA, CD-ROM, CD±R/RW, or the like) or a DVD standard (DVD±R/RW, DVD-RAM/ROM, or the like). Furthermore, a plurality of concentric annular zones having the same width are set logically and physically on the disk surface of the optical disk 100, and the optical disk apparatus 10 performs various controls of record/playback of the optical disk 100 for each zone.

An optical pickup 200 is a device for recording onto or playing back the optical disk 100 by means of an optical system comprising a light source, a lens, a photo-detector, and the like. The optical pickup 200 has a tracking/focusing servo actuator (not shown) and a tilt actuator 210 for tilt control incorporated therein. The tilt control is a control to make laser light emitted from an objective lens 220 of the optical pickup 200 orthogonal to a surface of the optical disk 100.

In particular, the tilt actuator 210 will be described in detail. The tilt actuator 210 takes on a structure that rotates the optical pickup 200 by using a stepping motor shown in, for example, FIG. 5 of Japanese Patent Application Laid-Open Publication No. 2003-77157, or a piezoelectric element, a cam mechanism, or the like. A tilt actuator driver 230 is provided as a device to drive the tilt actuator 210 and drives a stepping motor or the like of the tilt actuator 210 to rotate the optical pickup 200 or only the objective lens 220 in a radial direction or a tangential direction, thereby correcting the deviation of the optical axis of the laser light from being orthogonal to the surface of the optical disk 100.

Moreover, the optical pickup 200 is movably attached on a sled 240, which supports the optical pickup 200 so as to face the disk surface of the optical disk 100 and moves the optical pickup 200 in a radial direction of the optical disk 100. Hereinafter, the optical pickup 200 together with the sled 240 is called an optical pickup unit 250.

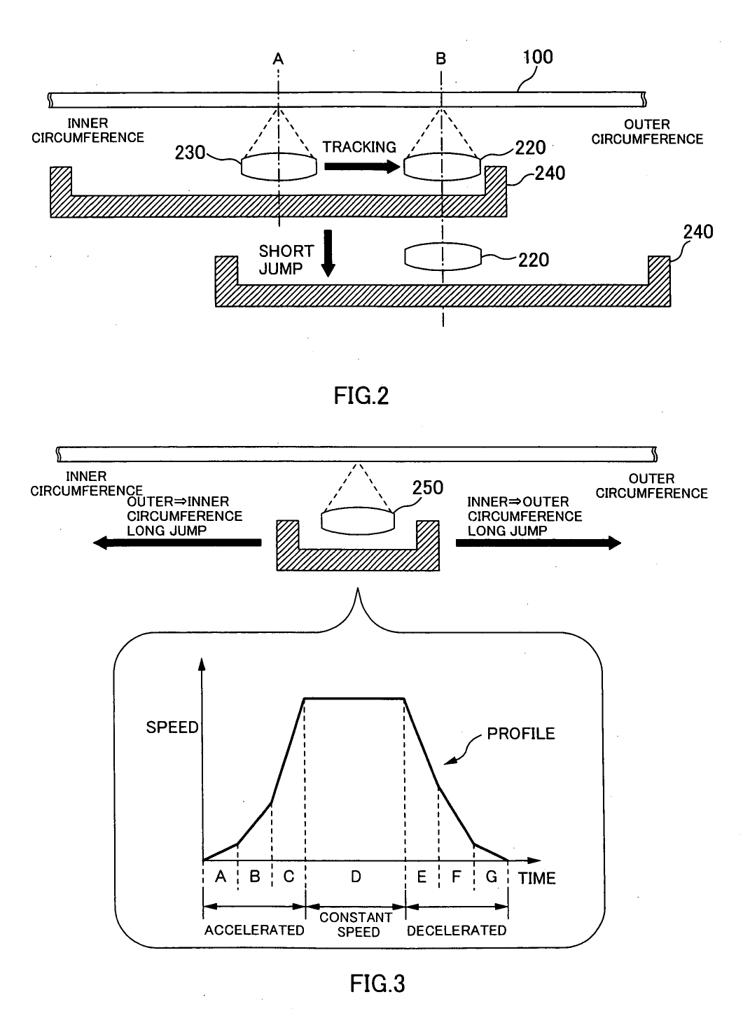

The movement of the optical pickup unit 250 includes a short jump and a long jump as well as a usual tracking servo operation. First, the short jump will be described. As shown in FIG. 2, when in the usual tracking servo operation, only the optical pickup 200 is moved with the sled 240 staying at a position. Then, when the optical pickup 200 approaches a limit of the range of movement on the sled 240, the sled 240 itself moves such that the optical pickup 200 returns to around the center on the sled 240. As a result, the optical pickup 200 is again put in a state of being movable on the sled 240. Also in the short jump, the operation similar to the usual tracking servo operation is performed.

Next, the long jump will be described. As shown in FIG. 3, the movement distance of the optical pickup 200 is set to be longer than the range of movement on the sled 240. The sled 240 with the optical pickup 200 is moved by the set distance. In this case, the sled 240 is controlled to accelerate and decelerate based on the following control profile. From the start of movement of the sled 240 until reaching a predetermined speed, the sled 240 is accelerated, and after reaching the predetermined speed, the sled 240 is made to move at a constant speed, and from before the target position at which the sled 240 stops, the sled 240 is decelerated.

A stepping motor 260 is usually used as a drive source for moving the optical pickup unit 250. The stepping motor 260 is a motor that rotates stepwise through predetermined step angles according to a predetermined input pulse series, and is driven by a stepping motor driver 270.

The methods of driving the stepping motor in the case of, for example, a two-phase stepping motor 260, are a one-phase excitation drive method, a two-phase excitation drive method, a one-two-phase excitation drive method, and a micro-step drive method. This invention is not limited to a two-phase stepping motor 260, but can adopt any of the above drive methods for the stepping motor 260. However, the case of an A/B phase (two-phase) stepping motor 260, which requires no more than a small number of switching elements of the stepping motor driver 270, wherein the micro-step drive method which can perform highly accurate positioning with high step resolution is adopted will be described below.

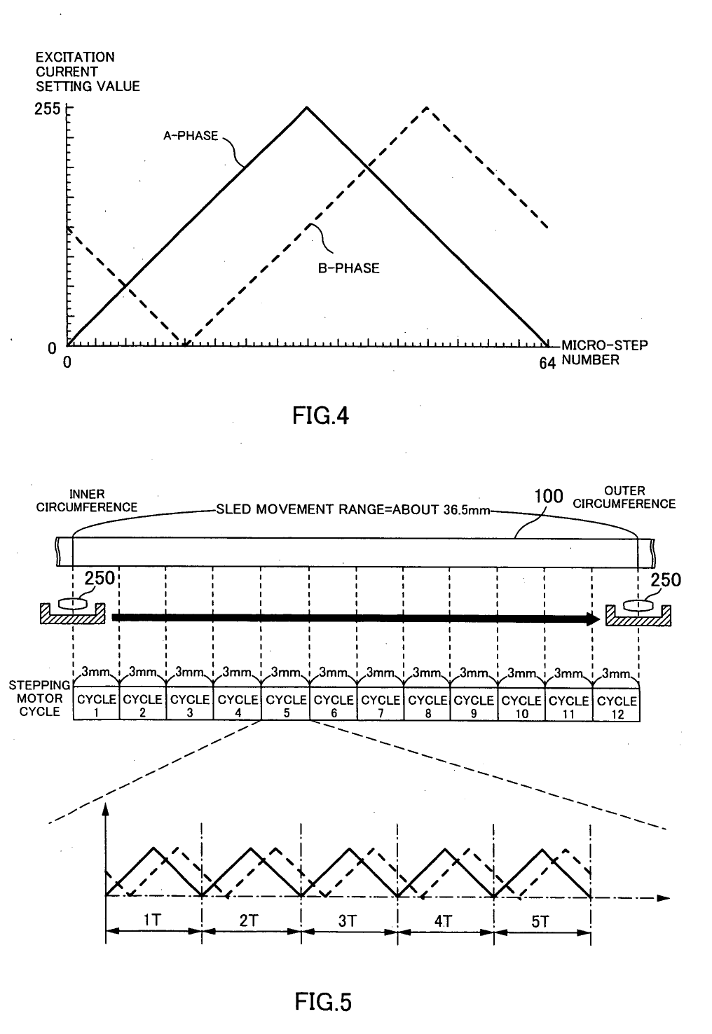

FIG. 4 is a waveform diagram of A/B phase current setting signals for use in the micro-step drive method according to the present invention. Note that the abscissa of FIG. 4 represents the number of a micro-step that is one step divided by N (a natural number, e.g., 64), the one step corresponding to the reference step angle of the stepping motor 260. That is, the stepping motor 260 rotating by one micro-step means rotating through the reference step angle divided by 64. Moreover, a unit on the ordinate of FIG. 4 represents a quantization level that is a setting range of excitation currents for the A/B phase motor drive coils divided by M (a natural number, e.g., 256).

As shown in FIG. 4, the A/B phase current setting signals are triangular wave signals that deviate by 90 degrees from each other which are for setting excitation currents for the A/B phase motor drive coils of the stepping motor 260 according to the micro-step number. In the micro-step drive method, a ratio of excitation currents for the A/B phase motor drive coils corresponding to each micro-step number is set according to the A/B phase current setting signals. And due to the set ratio of excitation currents for the A/B phase motor drive coils, the stepping motor 260 rotates through a rotation angle corresponding to one micro-step at each micro-step number.

Although it is possible to use sine wave signals as the A/B phase current setting signals, because triangular wave signals can be easily generated by a simple mechanism like a zone determination counter 416 described later, it is preferable in this invention to use the triangular wave signals as the A/B phase current setting signals.

Furthermore, in this invention, it is assumed that the reference step angle of the stepping motor 260 equals 72 degrees and that by five periods of the A/B phase current setting signals, the stepping motor 260 rotates through one cycle. Yet further, it is assumed that the movement range of the sled 240 is, for example, about 36.5 mm and that each time the stepping motor 260 rotates through one cycle, the sled 240 moves about 3 mm. In this case, it takes about 12 (≅36.5 mm/3 mm) cycles of the stepping motor 260 to move the sled 240 from the innermost circumference to the outermost circumference of the optical disk 100, and thus takes 60 periods (=12 cycles×5 periods/cycle) of the A/B phase current setting signals.

As such, by the periodic A/B phase current setting signals, the stepping motor 260 rotates through the rotation angle corresponding to the number of periods of the A/B phase current setting signals, and thus the optical pickup unit 250 moves the distance corresponding to the rotation angle of the stepping motor 260.

An analog signal processing device 300 performs analog signal processing for optical disk control, and comprises a preamp 310 that amplifies a photo-detected signal obtained by the optical pickup 200 from the optical disk 100, and a servo control signal generator 320 that produces a tracking error signal (hereinafter, a TE signal) for tracking servo and a focus error signal (hereinafter, an FE signal) for focus servo from the output of the preamp 310.

A digital signal processing device (a control circuit or device of the optical disk apparatus) 400 performs digital signal processing for optical disk control such as digital servo processing and encoding/decoding, which functions are implemented by hardware or software. The analog signal processing device 300 and digital signal processing device 400 may be embodied as a one-chip integrated circuit by using a CMOS analog process technology.

A spindle motor controller 410 controls the drive of the stepping motor 260 by the stepping motor driver 270. As described in detail later, the amount of movement from a current position to a target position of the optical pickup unit 250 is set, for the short jump, based on the TE signal supplied from the analog signal processing device 300, and for the long jump, based on the target number of micro-steps specified by a microcomputer 600. Then, the spindle motor controller 410 generates the A/B phase current setting signals to rotate the stepping motor 260 through the rotation angle corresponding to this amount of movement. In parallel with generating the A/B phase current setting signals, the spindle motor controller 410 detects the number of pulse periods of a triangular wave signal that is a reference for generating the A/B phase current setting signals.

A zone determination/control section 420 determines the zone which the optical pickup unit 250 is facing at the target position on the basis of the number of times when a pulse period of the triangular wave signal has been detected where driving the stepping motor 260 based on the A/B phase current setting signals.

Furthermore, the zone determination/control section 420 searches a zone control parameter value storage. 430 for zone control parameter values, for the determined zone, to be used for the control of record/playback of the optical disk 100, and then supplies the zone control parameter values to corresponding various drivers. Note that the zone control parameters may include optical pickup control parameters and an optical disk rotation speed control parameter, and are stored beforehand in association with a zone ID to identify each zone in the zone control parameter value storage 430.

Here, the optical pickup control parameter values are, for example, parameter values that are supplied for the tilt actuator driver 230 to correct the leaning of the laser optical axis for each zone (hereinafter, tilt correction values), and include a radial tilt correction value, a tangential tilt correction value, an offset correction value, a gain correction value, and the like. The tilt actuator driver 230 controls the drive of the tilt actuator 210 based on the tilt correction values supplied from the zone determination/control section 420.

The optical disk rotation speed control parameter is, for example, a parameter value that is supplied for a spindle servo controller 440, a division ratio setting section of a reproduction PLL circuit (not shown), and the like to set the linear or angular speed of the optical disk for each zone according to the ZCLV or ZCAV method or the like (hereinafter, a speed setting value). A spindle motor 500 is a motor to drive rotationally the optical disk 100, and the spindle servo controller 440 servo-controls the drive of the spindle motor 500 via a spindle motor driver 510 based on FG pulses detected by the spindle motor 500 and on the speed setting value supplied from the-zone determination/control section 420.

The microcomputer 600 controls the whole optical disk apparatus 10, and controls analog processing in the analog signal processing device 300, digital processing in the digital signal processing device 400, and the like overall.

===Configuration And Operation Of The Digital Signal Processing Device===

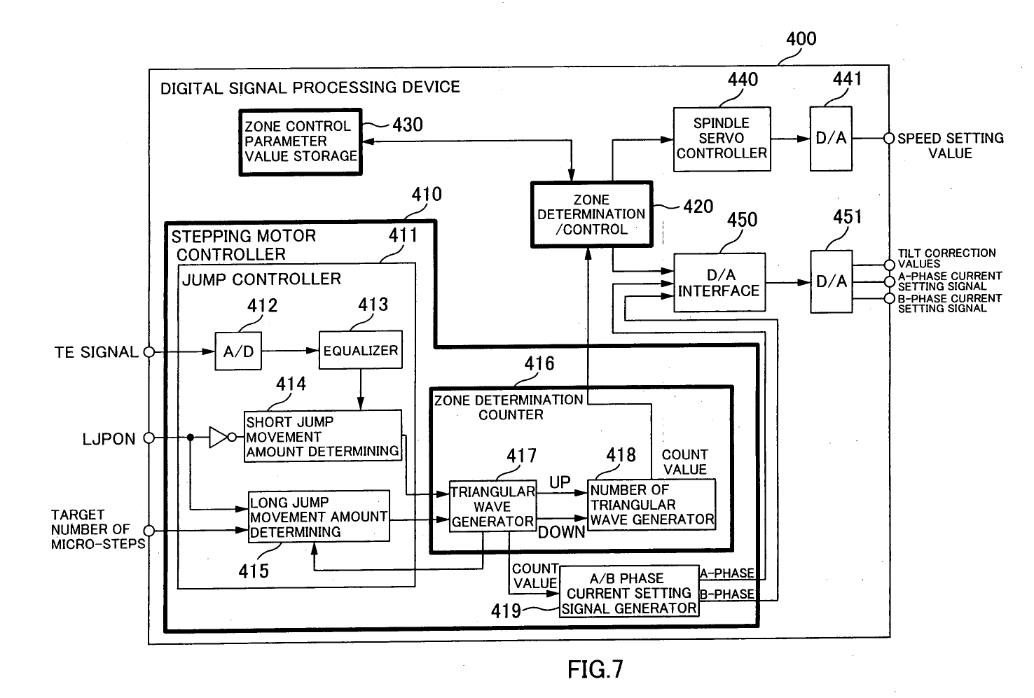

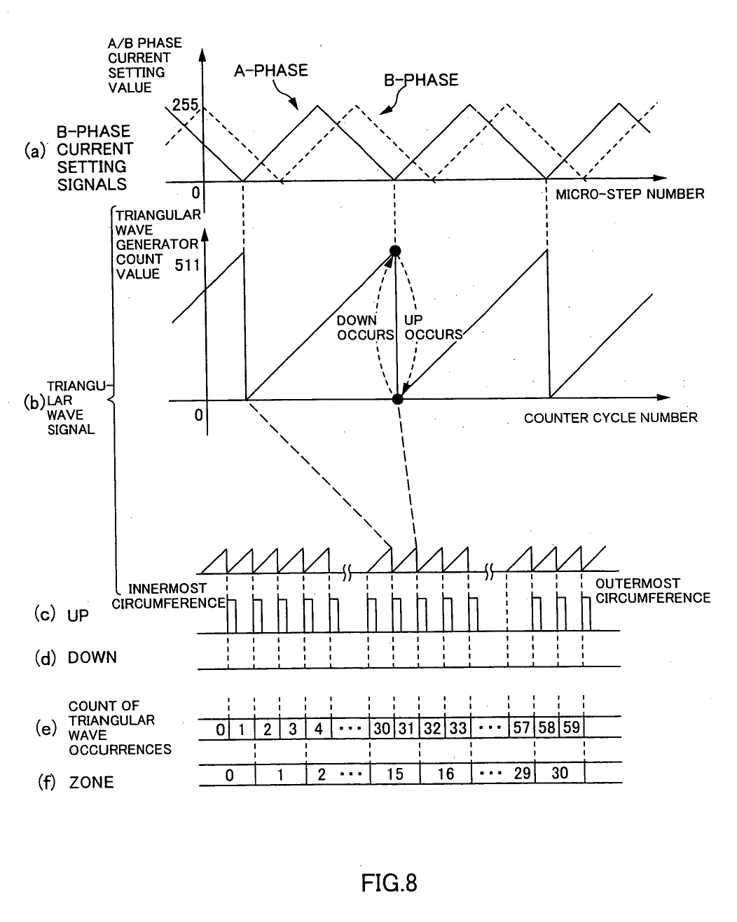

The configuration and operation of the digital signal processing device 400, an embodiment of the control circuit or device of the optical disk apparatus according to one embodiment of the invention, will be described in detail based on FIG. 7 with reference to FIGS. 8, 9, 10 as needed.

The spindle motor controller 410 comprises a jump controller 411, a zone determination counter 416, and an A/B phase current setting signal generator 419.

The jump controller 411 controls to set the amount of movement of the optical pickup unit 250 in the short jump or the long jump. Note that an LJPON signal shown in the Figure is a signal to select the control of a short jump mode or a long jump mode, and is supplied from the microcomputer 600 or generated in the spindle motor controller 410. For example, when the LJPON signal is at 0, a short jump movement amount determining section 414 becomes valid in operation to perform usual tracking servo or short jump control, and when the LJPON signal is at 1, a long jump movement amount determining section 415 becomes valid in operation to perform long jump control.

First, the short jump will be described. In usual tracking servo where a record track is traced with laser light, or in usual tracking servo before a short jump (a jump shorter in movement distance than long jumps) in the seek, the analog signal processing device 300 generates a TE signal (also called a traverse signal) from which can be determined the number of record tracks crossed by the laser light, that is, the movement amount of the optical pickup 200 on the sled 240. The jump controller 411 converts this TE signal into a digital signal by an A/D converter 412, and detects low band components of the converted TE signal by a low band pass filter (not shown) of an equalizer 413.

The short jump movement amount determining section 414 determines whether the movement amount of the optical pickup 200 on the sled 240 is within a tolerance range based on the low band components of the TE signal. If it is determined that the movement amount of the optical pickup 200 on the sled 240 is outside the tolerance range, the amount of short jump movement of the sled 240 is set so as to return the optical pickup 200 to a predetermined reference position on the sled 240 (e.g., the center on the sled 240) and supplied to the zone determination counter 416. As such, if the optical pickup 200 is located on the end of the sled 240 in usual tracking servo or short jumps, the control is performed whereby the sled 240 is so moved as to return the optical pickup 200 to the predetermined reference position on the sled 240.

Next, the long jump will be described. In the long jump mode, not the low band components of the TE signal but the target number of micro-steps specified by the microcomputer 600 is used. The long jump movement amount determining section 415 sets the amount of long jump movement for moving the optical pickup unit 250 from the current position to the predetermined reference position based on the target number of micro-steps and supplies the amount to the zone determination counter 416.

The zone determination counter 416 comprises a triangular wave generator 417 and a number of triangular waves counter 418. The triangular wave generator 417 is an embodiment of a “pulse control signal generator” according to the invention, and the number of triangular waves counter 418 is an embodiment of a “pulse period detector” according to the invention.

The triangular wave generator 417 generates a triangular wave signal as a reference for the A/B phase current setting signals by operation of count-up/down. That is, as shown in (a) and (b) of FIG. 8, the triangular wave generator 417 associates the number of micro-steps of the A/B phase current setting signals with the number of counter cycles in the count-up/down and further associates the excitation current setting values of the A/B phase current setting signals with the count value of the count-up/down. Note that the count-up is performed when the optical pickup unit 250 moves to the outer circumference side and the count-down is performed when the optical pickup unit 250 moves to the inner circumference side.

Then, the counter counts up to twice the quantization number (e.g., 256) of the excitation current setting value of the A/B phase current setting signals with being in phase with one of the A/B phase current setting signals, and each time a number (e.g., 64) of counter cycles corresponding to one period of the one of the A/B phase current setting signals elapse, the count is reset. In the example of FIG. 8, the triangular wave signal is in phase with the A phase current setting signal. In this way, the triangular wave signal having periodicity as shown in (b) of FIG. 8 is generated.

Meanwhile, each time one period of the triangular wave signal elapses, the triangular wave generator 417 generates an UP signal when counting up, and a DOWN signal when counting down. The example of FIG. 8 illustrates the case where the optical pickup unit 250 moves to the outer circumference side and only UP signals are generated as shown in (c) and (d) of FIG. 8.

The number of triangular waves counter 418 counts the number of times when a triangular wave has been generated in the triangular wave generator 417 or the number of periods. That is, each time the number of cycles counted up/down by the triangular wave generator 417 equals the number of cycles corresponding to one period of the triangular wave signal elapse, the number of triangular waves counter 418 counts up/down on the basis of the UP/DOWN signal supplied from the triangular wave generator 417. Note that (e) of FIG. 8 shows that the number of triangular waves counter 418 counts up on the basis of the UP signal shown in (c) of FIG. 8.

The triangular wave generator 417 and the number of triangular waves counter 418 of the zone determination counter 416 are preferably constituted by one up/down counter having a plural-bit register for simplicity of circuit configuration. For example, the triangular wave generator 417 is the lower-order register of the one up/down counter, which register has a corresponding number (e.g., 9) of bits to that of the excitation current setting values, and the number of triangular waves counter 418 is the higher-order register of the one up/down counter, which register counts carries from the lower-order register and has a corresponding number (e.g., 10) of bits to a predetermined number of carry times in the lower-order register.

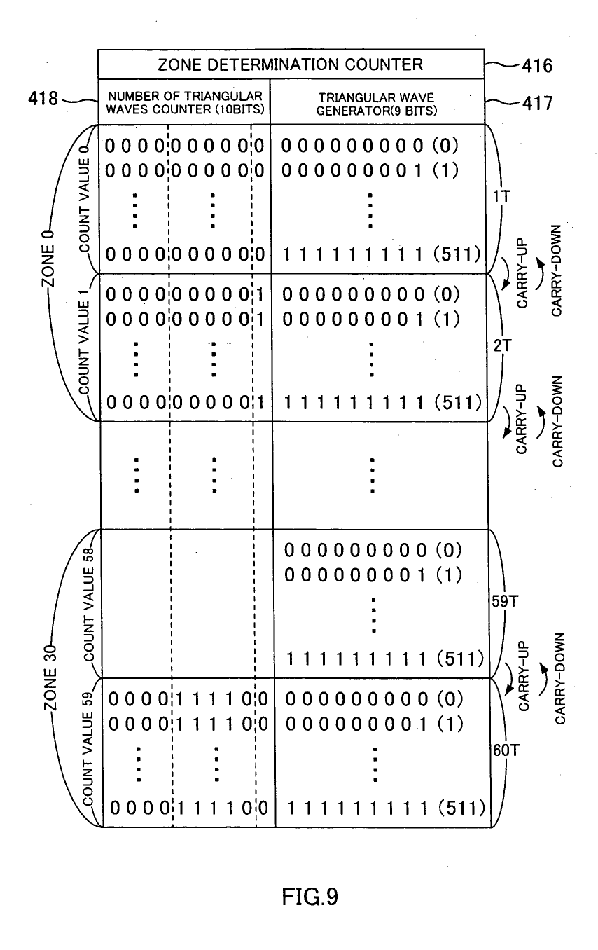

FIG. 9 shows the case where the zone determination counter 416 is constituted by a 19-bit register of which the lower-order 9-bit register is the triangular wave generator 417 and the higher-order 10-bit register is the number of triangular waves counter 418. As shown in FIG. 9, when the lower-order register counts up/down to change from the bits being all at 1 to being all at 0 or from the bits being all at 0 to being all at 1, which produces a carry-up/carry-down, one period of the triangular wave signal finishes.

Meanwhile, the higher-order register counts the number of carry-up/carry-down times in the lower-order register. Note that the number of bits of the higher-order register is decided depending on the specifications of the optical disk apparatus such as the number of periods of the triangular wave signal corresponding to one zone and the number of periods of the triangular wave signal necessary for the optical pickup unit 250 to move from the innermost circumference to the outermost circumference.

For example, in the case where one zone corresponds to two periods of the triangular wave signal as shown in (e) and (f) of FIG. 8 and where the optical pickup unit 250 moves from the innermost circumference to the outermost circumference in 60 periods of the A/B phase current setting signals (or 60 periods of the triangular wave signal), by using a total of 5 bits from the first bit next to the lowest order bit through the fifth bit of the higher-order register, the higher-order register can count the number of carry-up/carry-down times, which is up to a maximum of 59 times.

For example, in the case where it takes 120 periods of the triangular wave signal for the optical pickup unit 250 to move from the innermost circumference to the outermost circumference or where one zone corresponds to four periods of the triangular wave signal, a total of 5 bits from the second bit next but one to the lowest order bit through the sixth bit of the higher-order register are used.

The A/B phase current setting signal generator 419 generates the A/B phase current setting signals based on the triangular wave signal supplied from the triangular wave generator 417. For example, in the case of the triangular wave signal shown in (b) of FIG. 8, the count value of count-up/down increases/decreases linearly during one period, and the triangular wave signal is in phase with the A phase current setting signal.

The A/B phase current setting signal generator 419 generates the A phase current setting signal by decreasing the excitation current setting value after the count value for one triangular wave in the triangular wave generator 417 becomes equal to the maximum quantization number (e.g. 255) of the excitation current setting values such that the waveform is flipped and generates the B phase current setting signal by shifting the phase of the A phase current setting signal by 90 degrees, and supplies the A/B phase current setting signals generated to a D/A interface 450. As a result, the D/A interface 450 sends in a time division manner-the A/B phase current setting signals to a D/A converter 451, which converts into analog signals, which are supplied to the stepping motor driver 270.

When the stepping motor 2260 is driven based on the A/B phase current setting signals generated by the A/B phase current setting signal generator 419, the zone determination/control section 420 determines the zone that the optical pickup unit 250 is facing based on the number of times when a triangular wave has occurred counted by the number of triangular waves counter 418. For example, as shown in (e) and (f) of FIG. 8, in the case where one zone corresponds to two periods of the triangular wave signal, the zone determination/control section 420 can obtain a zone ID by dividing the number of triangular wave occurrence times by two and taking the integer.

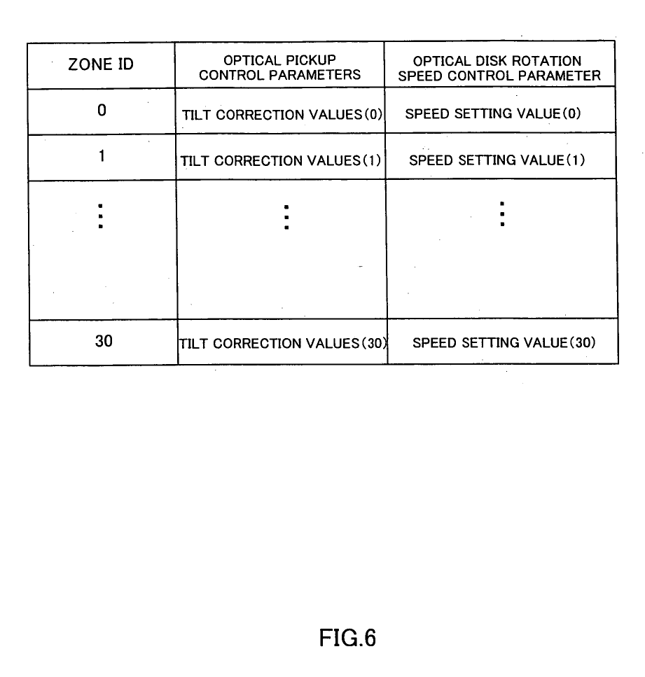

The zone determination/control section 420 searches the zone control parameter value storage 430 for the tilt correction value and speed setting value as the zone control parameter values for the zone of the zone ID as shown in, e.g., FIG. 6. The tilt correction value is sent to the D/A converter 451 via the D/A interface 450 like the A/B phase current setting signals, and converted by the D/A converter 451 into an analog signal, which is supplied to the tilt actuator driver 230. Meanwhile, the speed setting value is converted by the spindle servo controller 440 into an appropriate control signal, which is converted by the D/A converter 441 to analog form and supplied to the spindle motor driver 510.

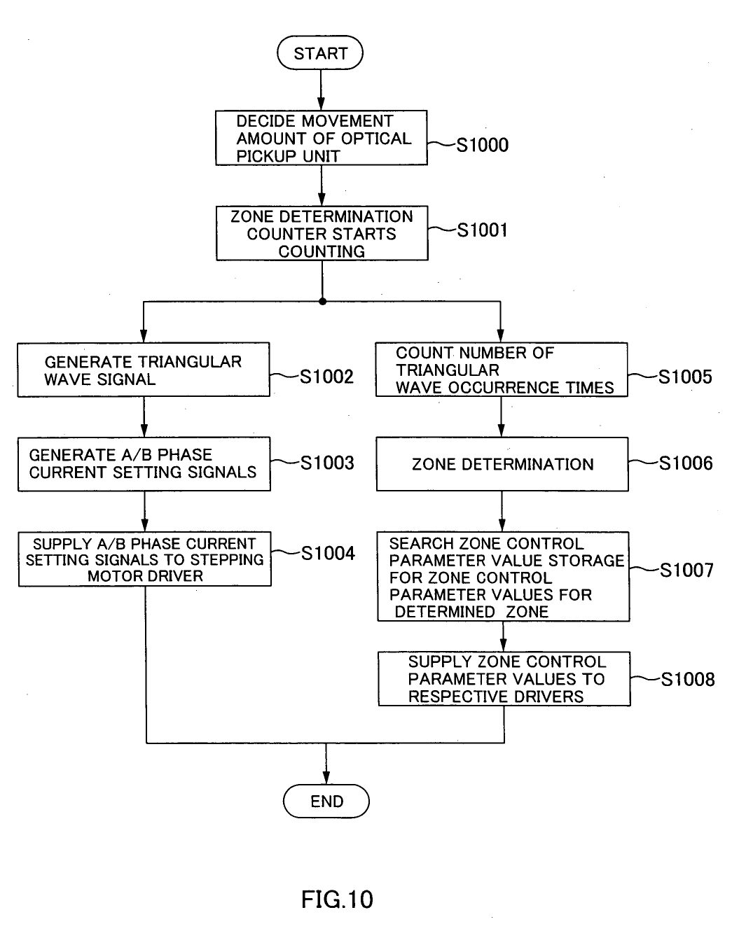

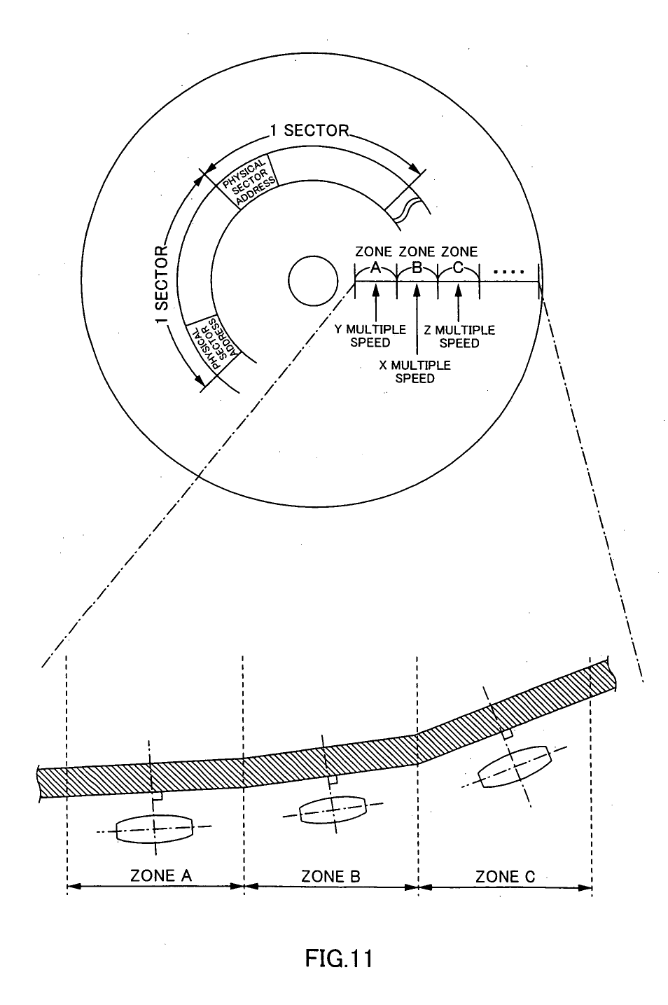

The configuration and operation of the digital signal processing device 400 according to the invention has been described. The flow of the operation of the digital signal processing device 400 will be described below based on the flow chart of FIG. 10. Note that the operation shown in FIG. 10 is performed by the digital signal processing device 400 unless otherwise stated.

First, when the optical pickup unit 250 is moved in the radial direction of the optical disk. 100, such as in a short jump or a long jump, the jump controller 411 decides the movement amount of the optical pickup unit 250 (S1000). Then, on the basis of the decided movement amount, the zone determination counter 416 starts counting (S1001). Then, the triangular wave generator 417 counts to generate the triangular wave signal (S1002). The count value is supplied to the A/B phase current setting signal generator 419. As a result, the A/B phase current setting signals are generated in order to move the optical pickup unit 250 by the decided movement amount (S1003). Then, the A/B phase current setting signals generated are converted by the D/A converter 451 into analog signals, which are supplied to the stepping motor driver 270 (S1004).

In parallel with the count operation of the triangular wave generator 417, the number of triangular waves counter 418 counts the number of triangular wave occurrence times (S1005). The zone determination/control section 420 determines the zone that the optical pickup unit 250 moved according to the A/B phase current setting signals is facing based on the counted number of triangular wave occurrence times (S1006). Next, the zone determination/control section 420 searches the zone control parameter value storage 430 for the zone control parameter values for the determined zone (S1007), and supplies to the respective drivers (S1008).

===Example of Effects===

According to an embodiment the present invention, where record/playback control adapted for each zone of the optical disk 100 is performed, physical addresses set on the optical disk 100 need not be read out in order to determine the zone of the optical disk 100 as in the background art. Hence, even when inappropriate physical addresses or no physical addresses are read out in seek operation or the like, the target zone can be detected based on the periodic pulse control signal for driving the motor to move the optical pickup unit 250. Therefore, the reliability of the zone determination and thus of record/playback control adapted for each zone of an optical disk can be improved.

Furthermore, according to an embodiment of the present invention, not the microcomputer 600 like in the background art but the digital signal processing device 400 determines the zone. Hence, with its processing load reduced, the microcomputer 600 can perform processing other than the zone determination fast.

Yet further, according to an embodiment of the present invention, the triangular wave signals or sine wave signals used conventionally for setting the excitation currents of motor drive coils in the stepping motor control are also used to determine the zone. That is, according to an embodiment of the present invention, utilizing effectively an existing mechanism of optical disk apparatuses such as the counter to generate the excitation current setting signal, the zone determination can be performed.

Still further, according to an embodiment of the present invention, the zone determination counter 416, an up/down counter, generates the triangular wave signals for setting the excitation currents of motor drive coils and in parallel therewith counts the number of periods of one triangular wave signal (number of wave occurrence times). Thus, the configuration of the digital signal processing device 400 can be simplified.

Moreover, according to an embodiment of the present invention, the digital signal processing device 400 has the zone control parameter value storage 430 in which are stored beforehand the control parameter values for record/playback control for each zone of the optical disk 100. Hence, the digital signal processing device 400 can perform record/playback control adapted for the determined zone of the optical disk 100 such as tilt control at high speed independently of the microcomputer 600.

Although in the above embodiment of the present invention the tilt control parameter values are taken as an example of the control parameter values for controlling adaptively for the determined zone, the invention is not limited to this. As another example, control parameter values for the PLL circuit to generate a clock signal in playback or write strategy setting values for controlling the intensity of laser light emitted from the optical pickup unit in recording can be used as the control parameter values.

Although the preferred embodiment of the present invention has been described, the above embodiment is provided to facilitate the understanding of the present invention and not intended to limit the present invention. It should be understood that various changes and alterations can be made therein without departing from spirit and scope of the invention and that the present invention includes its equivalents.

1. A control circuit provided in an optical disk apparatus which apparatus has a motor to move an optical pickup unit for performing record/playback control of an optical disk in a radial direction of the optical disk, sets a plurality of concentric annular zones on the optical disk, and performs record/playback control, for each zone, of the optical disk, the control circuit comprising:
a pulse period detector for detecting pulse periods of a periodic pulse control signal which drives the motor; and
a zone determination section that determines the zone which the optical pickup unit is facing on the basis of the number of pulse period detection times detected by the pulse period detector.

2. The control circuit for the optical disk apparatus according to claim 1, wherein the motor is a stepping motor, and the pulse period is a pulse period of a pulse control signal for rotating the stepping motor through a predetermined step angle.

3. The control circuit for the optical disk apparatus according to claim 2, wherein the pulse control signal is a periodic triangular wave signal according to a micro-step drive method where the number of steps corresponds to a rotation angle of the motor and where each of the steps is associated with an excitation current setting value for a motor drive coil provided in the motor, and wherein the pulse period detector detects periods of the triangular wave signal.

4. The control circuit for the optical disk apparatus according to claim 2, wherein the pulse control signal is a periodic sine wave signal according to a micro-step drive method where the number of steps corresponds to a rotation angle of the motor and where each of the steps is associated with an excitation current setting value for a motor drive coil provided in the motor, and wherein the pulse period detector detects periods of the sine wave signal.

5. The control circuit for the optical disk apparatus according to claim 3, further comprising:
a pulse control signal generator that associates the number of steps with a count of cycles of count-up/down and produces a count value of the count-up/down as the excitation current setting value for each step, and
wherein the pulse period detector counts up/down each time the count of cycles equals the number of cycles corresponding to one pulse period of the triangular wave signal, thereby detecting pulse periods of the triangular wave signal.

6. The control circuit for the optical disk apparatus according to claim 4, further comprising:
a pulse control signal generator that associates the number of steps with a count of cycles of count-up/down and produces a count value of the count-up/down as the excitation current setting value for each step, and
wherein the pulse period detector counts up/down each time the count of cycles equals the number of cycles corresponding to one pulse period of the sine wave signal, thereby detecting pulse periods of the sine wave signal.

7. The control circuit for the optical disk apparatus according to claim 5, wherein the pulse control signal generator and the pulse period detector are constituted by one up/down counter having a register of plural bits length, and
wherein the pulse control signal generator is a lower-order register of a corresponding number of bits length to the excitation current setting value of the up/down counter, and the pulse period detector is a higher-order register of the up/down counter, the higher-order register being for higher digits than the lower-order register and being of a corresponding number of bits length to a predetermined number of carry-up/down times in the lower-order register.

8. The control circuit for the optical disk apparatus according to claim 6, wherein the pulse control signal generator and the pulse period detector are constituted by one up/down counter having a register of plural bits length, and
wherein the pulse control signal generator is a lower-order register of a corresponding number of bits length to the excitation current setting value of the up/down counter, and the pulse period detector is a higher-order register of the up/down counter, the higher-order register being for higher digits than the lower-order register and being of a corresponding number of bits length to a predetermined number of carry-up/down times in the lower-order register.

9. The control circuit for the optical disk apparatus according to claim 1, further comprising:
a storage that stores, for each of the zones, control parameter values for record/playback control of the optical disk in association with the zone; and
a zone controller that searches the storage for the control parameter values in association with the determined zone and performs record/playback control of the optical disk adaptively for the determined zone based on the searched-for control parameter values.

10. The control circuit for the optical disk apparatus according to claim 9, wherein the control parameter values are control parameter values for tilt control to make an optical axis of laser light emitted from the optical pickup unit substantially orthogonal to a surface of the optical disk.

11. A method of performing record/playback control, for each zone, of the optical disk by a control device provided in an optical disk apparatus which apparatus has a motor to move an optical pickup unit for performing record/playback control of an optical disk in a radial direction of the optical disk and sets a plurality of concentric annular zones on the optical disk, the method comprising the steps of:
when a periodic pulse control signal to drive the motor is generated, detecting and counting pulse periods of the pulse control signal; and
when the motor is driven based on the pulse control signal, determining the zone which the optical pickup unit is facing at a target position on the basis of the number of pulse period detection times counted by the pulse period detector.
